(19) United States
(12) Patent Application Publication
(10) Pub. No.: US 2025/0064037 A1
(43) Pub. Date: Feb. 27, 2025

(54) Fishing Lure

(71) Applicant: Guangzhou Truscend Outdoor Leisure Goods Co., Ltd., Guangzhou (CN)

(72) Inventor: Haiyan Zhao, Guangzhou (CN)

(21) Appl. No.: 18/622,491

(22) Filed: Mar. 29, 2024

(30) Foreign Application Priority Data
Aug. 24, 2023 (CN) 202322281838X

(51) Int. Cl. A01K 85/18; A01K 85/00; A01K 85/01

(52) U.S. Cl. CPC A01K 85/18; A01K 85/017; A01K 85/1803

(57) ABSTRACT

A fishing lure includes a head part, a body part, a tail part and a flexible metal bill, wherein the head part is connected with the body part via at least two jointed connections; there are first metal spots provided on back-end of the head part and a horizontal opening on front end thereof; the body part is provided with second metal plates that the second metal plates smash the first metal spots when moving. The flexible metal bill that one end is provided on the horizontal opening, and another end extends away. By means of a segmented structure between the body part and the head part, it improves the fishing lure's swing range and makes it move more flexibly. The first metal spots and second metal plates smash to produce chattering noise to stimulate the predator's sensory perceptual system when moving.

### FIELD OF THE INVENTION

The invention related to the fishing lures area, particularly related to the crankbait fishing lure that dives under the water to imitate the bait fish's action.

### BACKGROUND OF THE INVENTION

The fishing lures are designed to mimic bait fish to attract the attention of predatory fish through appearance, colors, bright reflections, movements, vibrations and loud noises. The lures appeal to the fish's predation instinct and entice it into gulping the lure and then get hooked.

The prior art shown in FIG. 1 is a type of fishing lure that is mainly a one-piece structure body with a fixed plastic bill. The lure varies by different angles and lengths of the plastic bill to reach different depths. The fixed position of the bill, on one hand, ensures the diving action of the fishing lure, on the other hand, it prevents the lure from performing certain fish-attracting motions and vibrations. The plastic material of the bill can not reflect the light source effectively and the one-piece body can not create chattering sound in the movement.

Applicant notes that it is possible to upgrade the prior art's attraction to fish by providing a flexible metallic bill, as well as segmenting head and body, and arranging metal spots and metal plates on connecting bevels between the head and the body to produce noise. The flexible movement of the bill creates unique actions underwater, and the brightness of the metal bill increases the visual attraction. The segmented structure of the head and body or a multi-segmented body follows the fishing head part and presents the side-to-side swim action, which can not be found in the prior art. The metal spots and metal plates smash frequently to produce the metal chattering sounds.

### SUMMARY OF THE INVENTION

In order to solve the problems existing in the prior art, the present invention provides a fishing lure with a flexible metallic bill, a head part, a segmented body and a tail part, which has the characteristics of a flexible metallic bill so that a fishing lure moves more stably, reaches different depths, and imitates fish's action vividly, and bumping metal spots and metal plates smash frequently to produce chattering noise to be more attractive to fish. In the movement, the crankbait fishing lure integrates the reflection of spoon fishing lures, which can attract the fish more efficiently.

The technical solution of the present invention to solve the existing problems is: 1. A fishing lure comprising a head part, a body part, a tail part and a metallic bill; wherein the head part is connected with the body part via at least two jointed connections; the head part whose back end is provided with first metal spots, and front-end is provided with a horizontal opening; the body part is provided with second metal plates on front-ends, so that the second metal plates smash the first metal spots to produce chattering noise when moving; the metallic bill that one end pivotably connects to the horizontal opening, and another end extends away.

The present invention has beneficial effects: the present invention provides a segmented structure of head part and body part or multi-segmented body parts to make it move more flexibly and imitate fish action more vividly. Furthermore, by providing metal spots and metal plates arranged on opposite bevels between connection of the head part and the body part to produce chattering noise, it becomes more attractive to fish. In addition, the body part comprises at least one segmented body part, and two or more segmented parts connecting via flexible joints. In result, it can imitate different side to side actions that a lure of one-piece structure unable to do.

There is a horizontal opening built near the mouth area that enables the metallic bill to be connected with the body via mechanical means. The metallic bill flexible action changes the water flow, combining the metal parts' chattering sound, all present the visual and acoustic attraction to fish, which is not available in the conventional fishing lures. The flexible metallic bill guarantees the lure's stability in action and maneuverability for angler's operation.

### BRIEF DESCRIPTION OF DRAWINGS

FIG. 1 shows the prior art;

FIG. 2 shows a top plan view of the fishing lure for this invention;

FIG. 3 shows a bottom view thereof,

FIG. 4 shows a front side thereof,

FIG. 5 shows a rear side view thereof;

FIG. 6 shows a left side view thereof;

FIG. 7 shows a section view thereof,

FIG. 8 shows an explosive view thereof,

FIG. 9 shows another explosive view thereof, and

FIG. 10 shows another section view thereof.

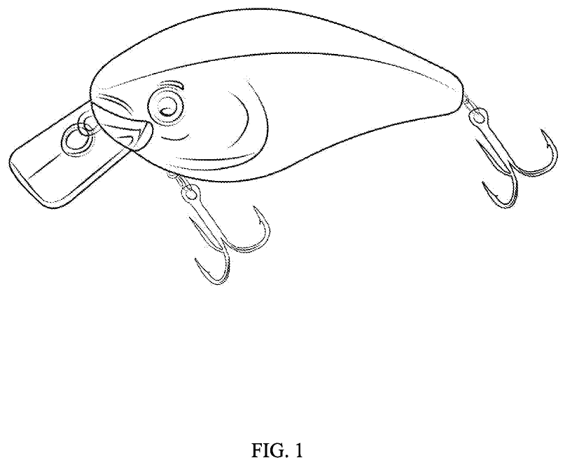

In the figures:
1—fishing lure, 11—head part, 111—first bevel, 101—horizontal opening, 102—fixed slot, 12—body part, 121—activity slot, 122—second bevel, 13—tail part, 2—first metal spot, 3—second metal plate, 4—articulated axle, 5—connecting ring, 6—metallic bill, 61—hole, 62—orifice, 7—shaft, 8—eyelet, 9—rattle bead, 10—stop device.

### DESCRIPTION OF EMBODIMENTS

The present disclosure is described in further detail below in conjunction with the figures.

This specific embodiment is only an explanation of the present disclosure, which is not a limitation of the present disclosure, and the person skilled in the art may make modifications to this embodiment without inventive contribution as needed after reading this specification, but as long as it is within the scope of the claims of the present disclosure it is protected by the patent law.

It should be noted that when an element is referred to as “fixed to” or “provided on” another element, it may be directly on the other element or indirectly on the other element. When an element is referred to as “connected to” another element, it may be connected directly to the other element or indirectly to the other element.

It should be understood that the terms “length”, “width”, “upper”, “lower”, “front”, “rear”, “left”, “right”, “vertical”, “horizontal”, “top”, “bottom”, “inside”, “outside” and the like indicate orientations or positional relationships based on those shown in the figures, and are intended only to facilitate the description of the present disclosure and to simplify the description, and are not intended to indicate or imply that the device or element referred to must have a particular orientation, be constructed and operated in a particular orientation, and therefore are not to be construed as a limitation of the present disclosure.

Furthermore, the terms “first” and “second” are used for descriptive purposes only and are not to be understood as indicating or implying relative importance or implicitly specifying the number of technical features indicated. Thus, a feature defined with the terms “first”, “second” may expressly or impliedly include one or more such features. In some descriptions of the present disclosure, “more than one” means two or more, unless otherwise expressly and specifically limited.

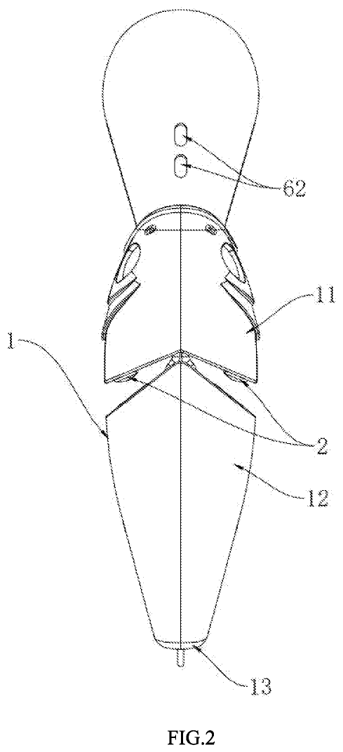

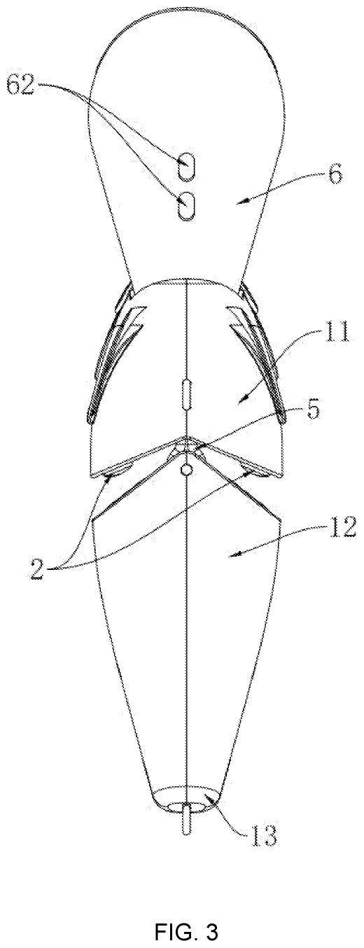

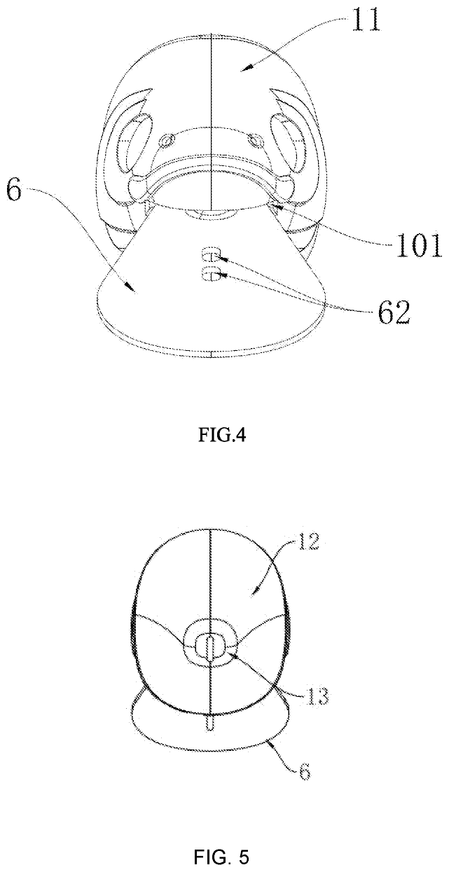

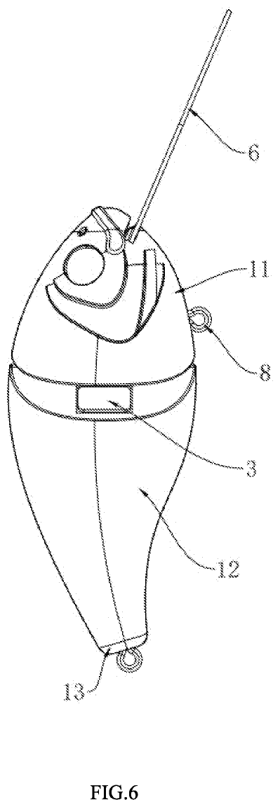

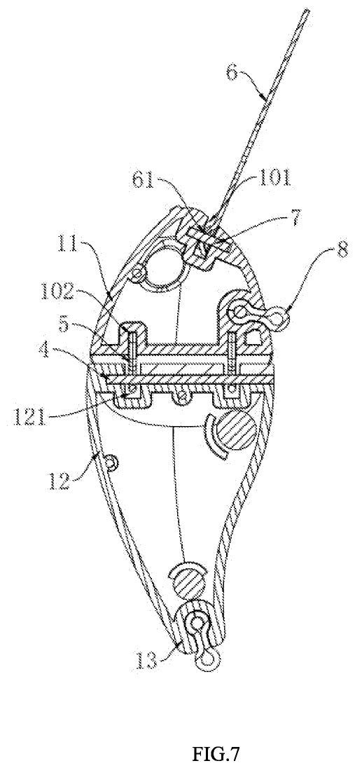

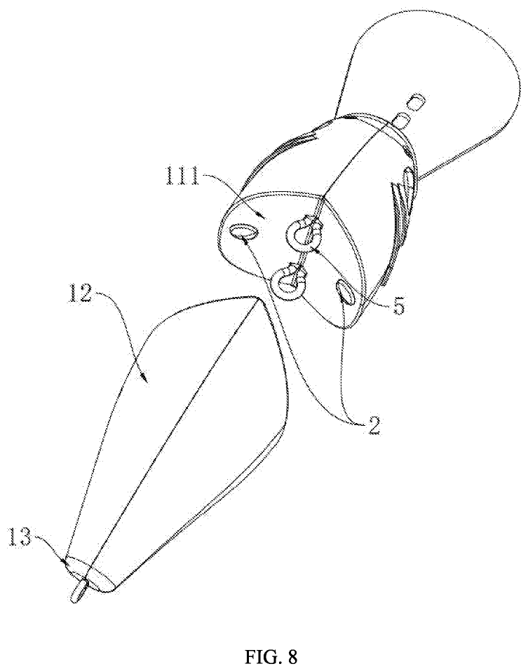

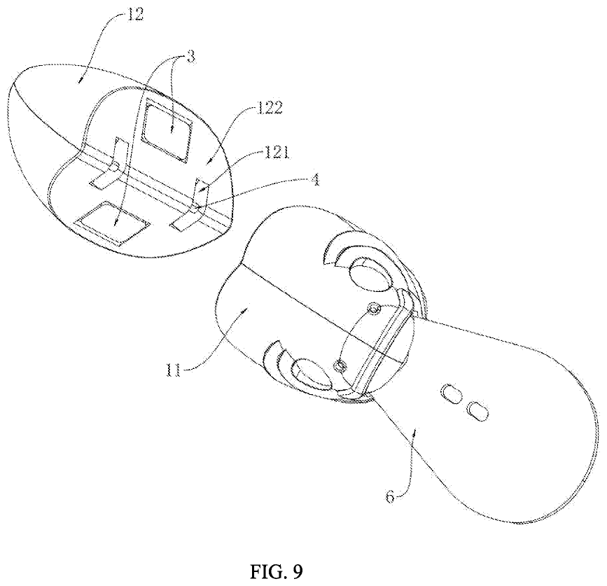

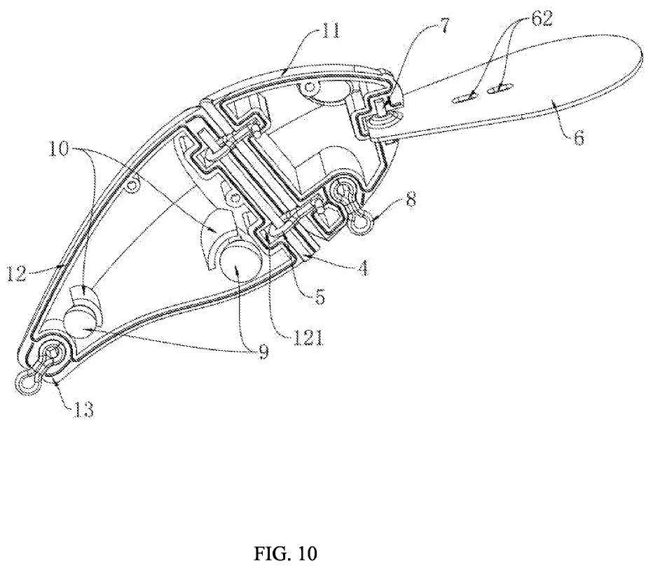

The embodiment relates to a fishing lure, as shown FIGS. 2-10, a fishing lure 1, comprising a head part 11, a body part 12, a tail part 13 and a flexible metallic bill 6.

The head part 11 is connected with the body part 12 via at least two jointed connections. The head part 11 that back ends is provided with first metal spots 2, and front-ends is provided with a horizontal opening 101. The body part 12 is provided with second metal plates 3 on front-ends, so that the second metal plates 3 smash the first metal spots 2 to produce chattering noise when moving. The metallic bill 6 that one end pivotably connects to the horizontal opening 101, and another end extends away. Besides, at least one or more first metal spots 2 is protruding on the surface of the head part's back ends. At its opposite direction on segmented body part, there are at least two or more corresponding metal plates 3. During the fishing lure 1 moving in the water, the segmented head part 11 and the body part 12 smash in a high frequency. Then the first metal spots 2 and second metal plates 3 smash frequently and produce rapid chattering noise, which seduces the predator to bite.

It should be noted that, the fishing lure 1 is designed based on the fish's profile, where a pair of eyes are set symmetrically on right and left side of the head part 11 to make the lure lifelike. Further, the fishing lure 1 has at least one eyelet 8 fixedly attached. The hook is connected to the fishing lure 1 through the eyelet 8. The fishing lure 1 may be covered with painting, foils, electroplate and other coating materials in one color or mixture of colors to simulate the appearance of various types of bait fish in fishing sports. There is at least one orifice 62 set on the metallic bill 6. The fishing line is attached to the orifice 62 arranged on the metallic bill 6. And the fishing line motivates actions of the fishing lure 1.

Optionally, the head part 11 that one end near the body part 12 is provided with a slot, and the body part 12 that one end near the head part 11 is provided with a convex corresponding to the slot. A slot can be triangle, polygon or oval shape and so on.

Preferably, the head part 11 is provided with two first bevels 111 that are connected to form a triangle slot; and there is at least one first metal spot 2 respectively provided on each first bevel 111; the body part 12 that one end near the head part 11 is provided with two second bevels 122 that are connected to form a triangle convex, and there is at least one second metal plate 3 provided on each second bevel 122 symmetrically. The triangle slot makes the body part 12 more flexibly move from right to left following the head part 11, so that the fishing lure 1 swing in the water more fishlike to lure the fish in action.

Further, one end of the head part 11 near the body part 12 is provided with fixed connecting rings 5, one end of the body part 12 that near the head part 11 is correspondingly provided with activity slots 121, and there is one articulated axle 4 inside the body part 12 that fixedly connected through the activity slots 121; the connecting rings 5 are pivotably connected to the articulated axle 4. A plurality of the connecting rings 5 and the activity slots are symmetrically arranged, and the articulated axle 4 is vertically passing through the activity slots 121. A number of the second metal plates 3 are arranged on two second bevels, and the second metal plates 3 are symmetrical with the articulated axle 4. Optionally, the first metal spots 2 are embedded on the first bevels 111, and the second metal plates 3 are relatively embedded on the second bevels 122.

Further more, one end of the head part 11 near the body part 12 is provided with fixed slots 102, parts of the connecting rings 5 are set inside the fixed slots 12, and then extend away so as to mechanically connect to the articulated axle 4.

Optionally, the body part 12 includes at least one segmented body part that can be mechanically connected via articulated axles 4 and connecting rings 5. The segmented structure of the fishing lure improves the movement of the lure under the water. In some embodiments, the tail part 13 is mechanically connected to one end of the body part 12 that is far away from the head part 11. In other embodiments, the tail part 13 and one body part 12 are of one-piece structure.

Optionally, the metallic bill 6 is pivotably connected inside the horizontal opening 101. Preferably, the metallic bill 6 is flat with a hole 61 arranged on the end inside the horizontal opening 101, a shaft 7 is arranged inside the horizontal opening 101. The shaft 7 vertically passes through the hole 61, then the metallic bill 6 is pivotally attached inside the horizontal opening 101.

In order to make the metallic bill 6 move more flexibly, not just move from side to side but also up to down, the diameter of the hole 61 is greater than the diameter of the shaft 7, the height of the horizontal opening 101 is greater that the thickness of the metallic bill 6, width of the horizontal opening 101 is larger than width of an end of the metallic bill 6 that is inside the horizontal opening 101. The present embodiment discloses a metallic bill 6 increasing in width from inside toward outside. In other embodiments, the metallic bill 6 is of rectangle or trapezoid but not exclusively.

In some embodiments, there is a cavity, rattle beads 9 and stop devices 10 inside the body part 12. The rattle beads 9 are arranged inside the stop devices 10, as a result, the rattle beads 9 strike stop devices in a limited space to create more noise. The striking noise and chattering noise together form a new sound effect underwater to better attract fish. In specific, the stop device 10 comprises a limited stop space and a striking pillar, wherein the rattle bead 9 and the striking pillar are set inside the limited stop space, and each rattle bead 9 is freely moving inside the limited stop space to strike the striking pillar to produce noise. Further, there is also a cavity inside the head part 11.

Optionally, the body part 12 of fishing lure 1 can be made of but not limited to plastic or metal material. The body part 12 can be made of acrylonitrile butadiene styrene, polymer, polycarbonate, carbon fiber, steel or any mixture of these materials.

It is also noted that although embodiments of the present disclosure have been shown and described, it will be appreciated by one of ordinary skill in the art that a wide variety of changes, modifications, substitutions, and variations of these embodiments can be made without departing from the principles and spirit of the present disclosure.

1. A fishing lure comprising a head part, a body part, a tail part and a flexible metallic bill;
wherein the head part is connected with the body part via at least two jointed connections;
the head part that back ends is provided with first metal spots, and front-ends is provided with a horizontal opening;
the body part is provided with second metal plates on front-ends, so that the second metal plates smash the first metal spots to produce chattering noise when moving;
the metallic bill that one end pivotably connects to the horizontal opening, and another end extends away.

2. The fishing lure according to claim 1, wherein the head part is provided with two first bevels that are connected to form a triangle slot; and there is at least one first metal spot respectively provided on each first bevel; the body part that one end near the head part is provided with two second bevels that are connected to form a triangle convex, and there is at least one second metal plate provided on each second bevel symmetrically.

3. The fishing lure according to claim 2, wherein connecting rings are fixedly arranged on one end of the head part near the body part; activity slots are arranged on one end of the body part near the head part to connect with the connecting rings; there is one articulated axle inside the body part that fixedly connected through the activity slots; the connecting rings are pivotably connected to the articulated axle.

4. The fishing lure according to claim 1, wherein the metallic bill is pivotably connected to the horizontal opening.

5. The fishing lure according to claim 1, wherein the metallic bill is flat and there is a hole arranged on one end of the metallic bill inside the horizontal opening, a shaft is arranged inside the horizontal opening to connect to the hole.

6. The fishing lure according to claim 5, wherein diameter of the hole is larger than diameter of the shaft, height of the horizontal opening is larger than thickness of the metallic bill, width of the horizontal opening is larger than width of an end of the metallic bill that is inside the horizontal opening.

7. The fishing lure according to claim 1, the body part further is with a cavity, rattle beads and stop devices inside, wherein the rattle beads and the stop devices are arranged inside the cavity, and the rattle beads are set inside the stop devices so that the rattle beads strike the stop devices to create more striking noise.
